(19) United States
(12) Patent Application Publication
(10) Pub. No.: US 2015/0362349 A1
(43) Pub. Date: Dec. 17, 2015

(54) THROUGHFLOW MEASUREMENT DEVICE FOR A BEVERAGE PREPARATION MACHINE

(71) Applicant: NESTEC S.A., Vevey (CH)

(72) Inventor: Markus STECKHAN, Mülheim (DE)

(21) Appl. No.: 14/761,187

(22) PCT Filed: Jan. 16, 2014
(86) PCT No.: PCT/EP2014/050780

§ 371 Date: Jul. 15, 2015

(30) Foreign Application Priority Data
Jan. 21, 2013 (DE) 20 2013 100 271.2

(51) Int. Cl. G01F 1/115; G01D 5/14

(52) U.S. Cl. CPC G01F 1/115; G01D 5/142

(57) ABSTRACT

The present invention concerns a throughflow measurement device for a beverage preparation machine for measuring the liquid delivered by means of a pump for beverage preparation, comprising a housing (3) which encloses a throughflow pathway, a rotary body (7) which is mounted within the housing (3) and which is driven by liquid delivered through the flow pathway and which has at least one encoder element (10, 10.1), and comprising a receiver unit (19) which is situated outside the housing (3) which encloses the throughflow pathway, said receiver unit being arranged so as to receive the signals from the at least one encoder element (10, 10.1), characterized in that the rotary body (7) has at least one drive body (9) which is arranged with its water-struck side inclined with respect to the longitudinal extent of the axis of rotation of the rotary body (7), and in that the housing (3) which encloses the throughflow pathway of the throughflow measurement device (1) is part of a module which exhibits further functionality, for example a water connection module (2), or of an assembly.

### FIELD OF THE INVENTION

The invention relates to a throughflow measurement device for a beverage preparation machine for measuring the liquid delivered by means of a pump for beverage preparation, comprising a housing which encloses a throughflow pathway, a rotary body which is mounted within the housing and which is driven by liquid delivered through the flow pathway and which has at least one encoder element, and comprising a receiver unit which is situated outside the housing which encloses the throughflow pathway, said receiver unit being arranged so as to receive the signals from the at least one encoder element.

### BACKGROUND OF THE INVENTION

Beverage preparation machines, for example coffee machines, in particular if they are in the form of so-called fully automatic machines, have a throughflow measurement device for detecting the liquid flow rate delivered by a pump. This information is required for beverage preparation. The pump delivers water from a storage vessel to a thermal block provided for heating water. With the use of a throughflow measurement device, a more precise detection of the delivered liquid flow rate is possible compared with an embodiment in which only the operating duration of the pump that delivers the liquid is detected and used as a basis for the beverage preparation. Furthermore, a beverage preparation machine of said type requires a water connection module to which the liquid pathways within the coffee machine are connected to the water supply. The throughflow measurement device is arranged between the water connection module and the pump and is connected to each of these by means of a hose.

Already-known throughflow measurement devices of the type mentioned in the introduction are throughflow measurement devices with a rotary body designed in the manner of a vane impeller. The vane impeller is arranged so as to be rotatably mounted in a housing. To drive the vane impeller, the housing has an inlet duct which is arranged tangentially with respect to the vane impeller in order that the inflowing fluid strikes the blades, oriented with their plane parallel to the axis of rotation of the vane impeller, as drive bodies of the rotary body designed as an impeller. Part of the housing is a central outlet duct through which the delivered liquid is conveyed out of the throughflow measurement device from the region of the axis of rotation of the impeller and supplied for the beverage preparation. The vane impeller bears at least one magnet as a encoder element. On the outer side of the housing, in alignment with the path of rotation of the at least one magnet, a Hall sensor as a magnetosensitive receiver is arranged such that a movement of the passing magnet can be detected. The rate of rotation of the vane impeller is detected in this way. Since the housing volume and the parameters required for driving the vane impeller with regard to its rate of rotation are known, the liquid flow rate delivered through the housing of the vane impeller can be inferred from the rate of rotation of the vane impeller per unit of time.

Even though the liquid flow rate delivered by a pump for the preparation of a beverage can be determined with substantially adequate accuracy by means of a throughflow measurement device of said type, there are nevertheless disadvantages that must be accepted. These relate for example to the required size of the housing, which is disadvantageous for embodiments in which only limited installation space is available. Owing to the size, a throughflow measurement device of said type therefore sometimes cannot be arranged at the actually desired position in a beverage preparation machine, but only at a position at which adequate installation space is available. In the case of such an embodiment, it is also necessary to accept the amount of water that remains in the housing after the end of a pumping process, which amount of water is supplied for the beverage preparation at the start of the next liquid delivery process. This residual liquid amount supplied for the beverage preparation is only inadequately allowed for by a rotational movement of the vane impeller, such that in this regard, the liquid metering for the preparation of the desired beverage is subject to certain fluctuations.

Taking this discussed prior art as a starting point, the invention is based on the object of proposing a throughflow measurement device for a beverage preparation machine which can be realized in a more space-saving form and thus with a small structure.

### SUMMARY OF THE INVENTION

Said object is achieved according to the invention by means of a generic throughflow measurement device as mentioned in the introduction in which the rotary body has at least one drive body which is arranged with its water-struck side inclined with respect to the longitudinal extent of the axis of rotation of the rotary body, and in which the housing which encloses the throughflow pathway of the throughflow measurement device is part of a module which exhibits further functionality, for example a water connection module, or of an assembly.

In the case of the throughflow measurement device according to the invention, the rotary body has drive bodies arranged with an inclination, said drive bodies being inclined with respect to the axis of rotation of the rotary body. By means of this measure, it is possible for the rotary body, with its at least one encoder element, to be able to be struck by flow axially in order to have imparted to it the rotational movement required for a throughflow measurement. Consequently, in the case of such an embodiment, the rotary body can be arranged with its plane transversely with respect to the main flow path in a section of the throughflow pathway. In the case of such an installation arrangement, the rotary body requires only a particularly small installation space. Ultimately, the required installation space, and installation length in the flow direction of the liquid, is merely such that the required freedom of movement is greater than the height of the rotary body. It is self-evident that, owing to this, less installation space is required within a beverage preparation machine than is the case with rotary bodies that are struck by flow tangentially. The inclined arrangement of the at least one drive element also makes it possible, for example, for the inclination to be set such that the rotary body rotates more rapidly than would correspond to the actual flow speed of the water through the flow pathway. With the rotary body, the at least one encoder element also rotates more rapidly as a result, which increases the measurement accuracy. This is applicable in particular if the flow speed through the throughflow pathway is not particularly high. Furthermore, an axial impingement of flow on the rotary body ensures that not only is the flow occurring within the throughflow pathway detected spontaneously, but the entirety of the water flow rate delivered is associated with the present pumping process. In this respect, the throughflow measurement device can be configured such that there is no remaining liquid dead space.

For a further reduction of installation space, it is provided that the housing of the throughflow measurement device is part of a further module or assembly of the beverage preparation machine, for example part of a water connection module. Owing to the special configuration of the connection measurement device, this is readily possible, in particular also without the need for a relatively large installation space. In the case of an embodiment of said type, the housing of the further assembly or module is typically likewise the housing required the throughflow pathway of the throughflow measurement device. If a module of said type is a water connection module, this has an inlet opening via which the water connection module can be connected, or in the installed state is connected, to a water supply, for example to a fresh water storage vessel of a beverage preparation machine.

In a preferred exemplary embodiment, the rotary body has multiple drive bodies which are arranged at angular intervals with respect one another and which are in the form of blades. It is by all means also possible for the rotary body to have only one or two drive bodies which are then formed in the manner of a helix or a segment of a helix.

To improve the impingement of flow, at least one drive body of the rotary body is, it is provided according to one refinement that a guide element is positioned upstream of the rotary body in the flow direction. The guide element serves for diverting the water which flows into the housing, or into the housing section in which the rotary body is rotatably mounted, onto the at least one drive body. Said drive body is typically connected to the hub of the rotary body in the radial direction. In the case of such an embodiment, the guide element then serves to channel or divert the inflowing water into a flow path which is situated radially at the outside and in which the one or more drive bodies are situated. Said guide element may be in the form of a plate which inhibits the free flow through the throughflow pathway and which has one or more apertures for allowing the delivered liquid to pass through. Said apertures are preferably situated in alignment with the at least one drive body in an axial direction. If multiple drive bodies are provided, it is expedient for the guide element to have multiple apertures, typically situated diametrically opposite one another with respect to the axis of rotation of the rotary body.

To further improve the drive of the rotary body, provision may be made for the apertures in the guide element to be inclined, with regard to their longitudinal axes, in the opposite direction to the inclination of the drive bodies of the rotary body. In this case, it is provided in a preferred exemplary embodiment that the inclination of the longitudinal axes of the apertures is configured such that the longitudinal axes of said apertures run perpendicular to the water-struck surfaces or to the drive bodies of the rotary body.

It is self-evident that, if the guide element is formed with one or more apertures, even the slightest movements of water within the throughflow pathway are detected.

In a further preferred exemplary embodiment, provision is made for the rotary body to be formed between the guide element and a base as part of the housing which encloses the throughflow pathway. For this purpose, it is preferable for the guide element to bear against a stop which points counter to the flow direction, and to bear a first bearing pivot which points in the direction of the base. A second bearing pivot projects from the base itself so as to be aligned with the first bearing pivot of the guide element. Both bearing pivots engage into corresponding bearing bushings of the rotary body. Instead of the above-described mountings of the rotary body on the first and second bearing pivots, it is also possible for the rotary body to bear one or even both of said bearing pivots, which bearing pivots then engage into a corresponding bearing bushing of the guide element and/or of the base. In an embodiment as described above, the base simultaneously serves for diverting the main flow path, specifically for example from an inlet opening into an outlet arranged at an angle with respect to said inlet opening. In the case of such an embodiment, it is expedient for the base to be simultaneously utilized as a carrier for the receiver unit. In the case of such an embodiment, the base preferably has a chamber for accommodating the receiver unit.

Magnets are typically provided as the one or more encoder elements. A correspondingly magneto-sensitive receiver, typically a Hall sensor, serves as a receiver unit.

In many cases, a throughflow measurement device of said type, which is part of a water connection module, likewise has a filter installed therein. Said filter is positioned upstream of the rotary body in the flow direction of the delivered liquid.

The positioning of the rotary body with its at least one encoder element directly in the throughflow pathway, in conjunction with the above-described design of the one or more drive bodies, basically also permits a detection of liquid movements within the throughflow pathway counter to the actual delivery direction. In this way, with a throughflow measurement device of said type, it is also possible to detect liquid flows counter to the main delivery direction even if such flows are likely to only be small. The liquid flow rate actually delivered by the pump for the preparation of a beverage is then detected with correspondingly greater accuracy.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 shows a perspective view, in the form of exploded illustration, of a throughflow measurement device integrated into a water connection module;

FIG. 2 shows, in a cross section, the throughflow measurement device of FIG. 1 integrated into the water connection module, and

FIG. 3 shows the assembly illustration of FIG. 2 in a second section plane offset through 90°.

### DETAILED DESCRIPTION OF THE INVENTION

A throughflow measurement device 1 for detecting the liquid volume delivered by a pump is, in the exemplary embodiment illustrated, integrated into a water connection module 2. The water connection module 2 comprises a housing 3. The latter is of substantially cylindrical design and has a water inlet 4 which, in the exemplary embodiment illustrated, is the upper opening of the housing 3. A water line connection piece of a water supply, for example a hose piece connected to a water storage vessel, is inserted into the water inlet 4 or into the opening provided through the housing 3 for this purpose. Said hose piece seals, by way of its outer wall, against the inner wall of the housing 3. The water outlet 5 of the water connection module 2 is in the form of a nozzle. When the water connection module 2 with its throughflow measurement device 1 is used in a beverage preparation machine, for example a coffee machine, the suction hose which is connected to a pump is mounted onto the outlet 5. The outlet 5 runs in a radial direction with respect to the longitudinal axis of the housing 3.

Part of the water outlet module 2 is a screen plate 6 arranged within the housing 3.

The throughflow measurement device 1 of the exemplary embodiment illustrated in the figures comprises a rotary body 7. The rotary body 7 is formed in the manner of an impeller and comprises a hub 8 on which multiple drive bodies in the form of blades 9 are integrally formed so as to project in the radial direction. The blades 9 are inclined relative to the longitudinal axis of the rotary body 7. In the exemplary embodiment illustrated, the inclination of the blades 9 is approximately 45°.

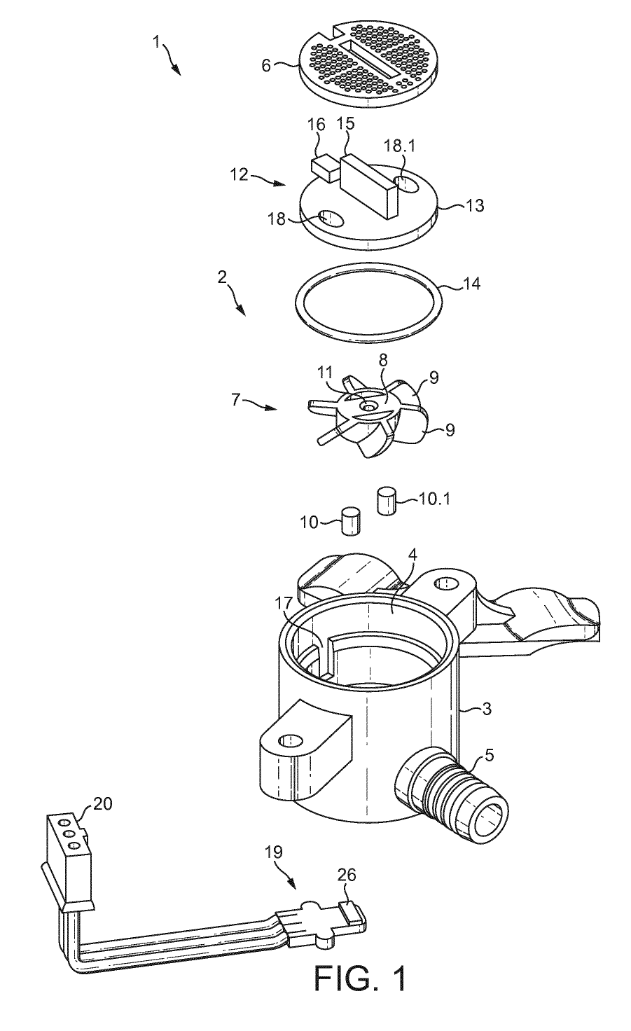

The underside (not visible in FIG. 1) of the hub 8 has provided therein two cylindrical receptacles which are situated diametrically opposite one another with respect to the axis of rotation of the rotary body 7 and into which there is inserted in each case one encoder magnet 10, 10.1. Bearing bushings 11 are inserted into the rotary body 7, proceeding from the two flat sides of the hub 8, so as to be in alignment with the longitudinal axis and axis of rotation of said rotary body.

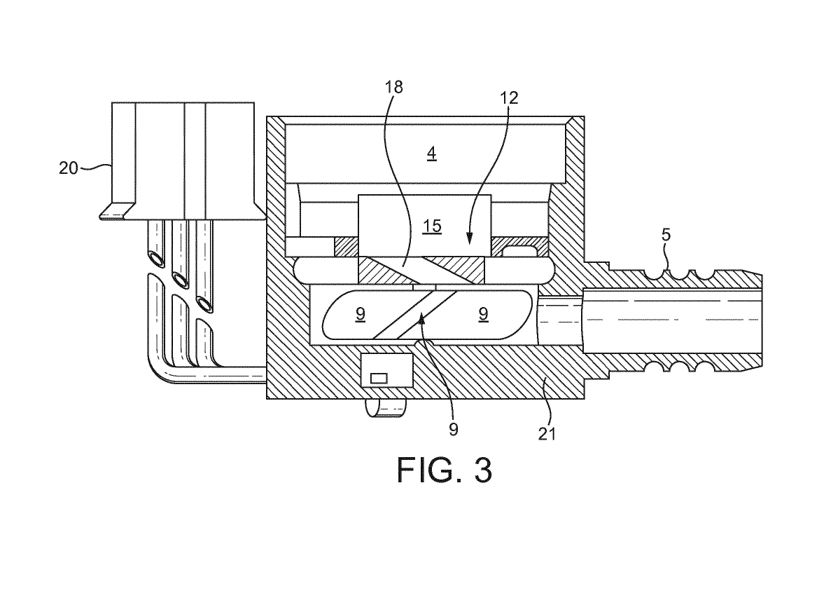

Positioned directly upstream of the rotary body 7 in the flow direction is a guide element 12 which bears sealingly, with a sealing ring 14 accommodated in the radial direction in an encircling groove 13, against the inner wall of the housing 3. On its side pointing toward the screen plate 6, the guide element 12 has a handle 15 formed in the manner of a lug and has an assembly coding means 16 that projects in the radial direction. The assembly coding means 16 engages into a groove 17, which runs in the direction of the longitudinal axis, on the inner wall of the housing 3. The guide element 12 has two apertures 18, 18.1. These are arranged diametrically opposite one another. The apertures 18, 18.1 serve for allowing drawn-in liquid to pass through. The apertures 18, 18.1 are situated in alignment with the blades 9, situated immediately downstream thereof as viewed in the flow direction, of the rotary body 7. In the exemplary embodiment illustrated, the apertures 18, 18.1 are inclined in the opposite direction to the inclination of the blades 9 of the rotary body 7 (see FIG. 3).

The throughflow measurement device 1 also encompasses a receiver unit 19 to which a connection cable is connected by way of a connection plug 20. The receiver unit 19 comprises a Hall sensor.

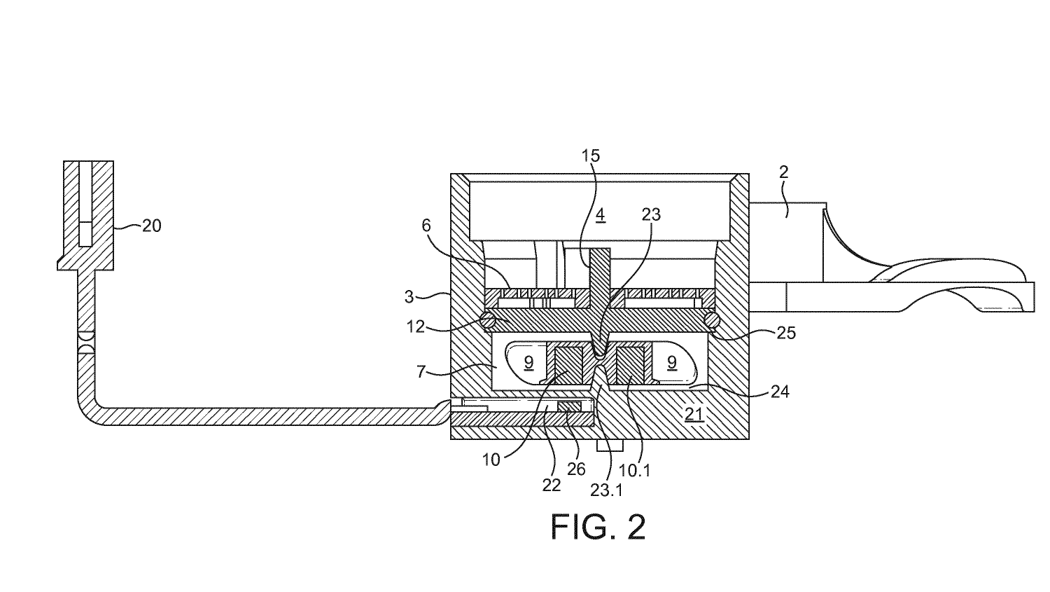

The arrangement of the above-described parts of the water connection module 2 with its throughflow measurement device 1 can be seen from the cross-sectional illustration of FIG. 2. The housing 3 has, on the underside, a base plate 21 which forms the lower termination of the housing 3. At the same time, the base plate 21 diverts the inflowing liquid in the direction of the outlet 5. A chamber 22 for accommodating the receiver unit 19 is formed into the base plate 5. The chamber 22 is open in the radial direction such that the receiver unit 19 can be pressed into the chamber 22 from the side and fixed therein.

Two bearing pivots 23, 23.1 serve for the mounting of the rotary body 7 within the housing 3. One of the two bearing pivots—the bearing pivot 23—is integrally formed on the guide element 12. The second bearing pivot 23.1 is integrally formed, so as to be aligned with the bearing pivot 23, on that side of the base plate 21 which forms the base 24. Both the bearing pivots 23, 23.1 are of conical form. The bearing pivots 23, 23.1 engage into the bearing bushings 11, which are of complementary design with regard to their geometry, of the rotary body 7. The guide element 12 is seated on a shoulder 25, the shoulder surface of which points in the direction of the water inlet 4. Mounted on and held by the handle 15, the screen plate 6 is situated on that side of the guide element 12 which points towards the water inlet 4.

FIG. 2 also shows the fact that the movement path of the encoder magnet 10, 10.1 (in this case of the encoder magnet 10) and the Hall sensor 26 of the receiver unit 19 are arranged in alignment in the longitudinal axial direction.

In a sectional illustration with a section plane offset through 90° with respect to the section plane of FIG. 2, the section plane passing through an edge in the region of the guide element 12, FIG. 3 shows the inclination of the aperture 18 relative to the, in this respect, oppositely inclined arrangement of the blades 9 of the rotary body 7.

Integrally formed on the outer side of the housing 3 are fastening elements by means of which the housing is fastened in a machine, in this case a beverage preparation machine.

The water connection module 2 with its throughflow measurement device 1 is, in accordance with one of its possible uses, used as part of a beverage preparation machine, for example of a so-called fully automatic coffee machine.

The description of the exemplary embodiment illustrated in the figures shows that the throughflow measurement device 1 requires only an extremely small amount of installation space. The installation space otherwise required for the water connection module 2 is increased only to an insignificant extent by the throughflow measurement device 1.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. Throughflow measurement device for a beverage preparation machine for measuring the liquid delivered by a pump for beverage preparation, comprising a housing which encloses a throughflow pathway, a rotary body which is mounted within the housing and which is driven by liquid delivered through the flow pathway and which has at least one encoder element, and comprising a receiver unit which is situated outside the housing which encloses the throughflow pathway, the receiver unit being arranged so as to receive the signals from the at least one encoder element, the rotary body has at least one drive body which is arranged with its water-struck side inclined with respect to the longitudinal extent of the axis of rotation of the rotary body, and the housing which encloses the throughflow pathway of the throughflow measurement device is part of a module which exhibits further functionality.

2. Throughflow measurement device according to claim 1, wherein the rotary body is arranged in the housing with its axis of rotation parallel or at least substantially parallel to the direction of the main flow path of the water in the housing section in which the rotary body is mounted.

3. Throughflow measurement device according to claim 1, wherein the rotary body has multiple drive bodies which are arranged at angular intervals with respect one another and which are in the form of blades.

4. Throughflow measurement device according to claim 1, wherein directly upstream of the rotary body in the flow direction, there is provided a guide element for diverting the inflowing water onto the at least one drive body of the rotary body.

5. Throughflow measurement device according to claim 1, comprising a guide element which is a plate which inhibits a free flow through a throughflow pathway and into which at least one aperture is formed in alignment with the at least one drive body of the adjacent rotary body.

6. Throughflow measurement device according to claim 5, wherein the longitudinal axis of the at least one aperture is inclined in the opposite direction to the inclination of the at least one drive body.

7. Throughflow measurement device according to claim 6, wherein the longitudinal axis of the at least one aperture runs approximately perpendicular to the water-struck surface of the at least one drive body of the rotary body.

8. Throughflow measurement device according to claim 1, comprising a guide element that rests on a shoulder which is situated in the housing and which points counter to the flow direction.

9. Throughflow measurement device according to claim 8, wherein a base plate is provided downstream of the shoulder in the flow direction, as part of the housing which encloses the throughflow pathway, the baseplate being provided for diverting the flow direction of the water in the direction of an outlet.

10. Throughflow measurement device according to claim 9, wherein in an aligned arrangement with respect one another, the guide element bears a first bearing pivot which projects in the direction of the base of the base plate, and the base bears a second bearing pivot which projects in the direction of the guide element, for the mounting of the rotary body.

11. Throughflow measurement device according to claim 8, wherein a chamber with the receiver unit arranged therein is provided in the base plate.

12. Throughflow measurement device according to claim 1, wherein the at least one encoder element is a magnet, and the receiver unit is in the form of a magneto-sensitive receiver.

13. Throughflow measurement device according to claim 12, wherein the at least one encoder magnet is arranged in the hub of the rotary body.

14. Throughflow measurement device according to claim 1, wherein the throughflow measurement device is part of a water connection module.
